(19) United States
(12) Patent Application Publication
(10) Pub. No.: US 2012/0202137 A1
(43) Pub. Date: Aug. 9, 2012

(54) BIPOLAR PLATE ASSEMBLY WITH ADHESIVE BOND LAYER AND METHOD THEREOF

(75) Inventors: Ingrid A. Rousseau, Clinton Township, MI (US); Richard Pryce Atkins, Utica, MI (US); William R. Rodgers, Bloomfield Township, MI (US)

(73) Assignee: GM GLOBAL TECHNOLOGY OPERATIONS LLC, Detroit, MI (US)

(21) Appl. No.: 13/020,892

(22) Filed: Feb. 4, 2011

(51) Int. Cl. H01M 4/02; H01M 4/04

(52) U.S. Cl. 429/518; 156/291

(57) ABSTRACT

One embodiment includes a bipolar plate assembly with an adhesive bond layer. The bipolar plate assembly is used in a fuel cell stack and includes a first plate and a second plate. The first plate has a first border and the second plate has a second border. The adhesive bond layer is located between the first border and the second border, and is used to mechanically and structurally join the first plate and the second plate together.

### TECHNICAL FIELD

The technical field generally relates to products including bipolar plate assemblies used in fuel cell stacks, and ways of joining bipolar plate assemblies.

### BACKGROUND

Bipolar plate assemblies are commonly used as components of a fuel cell stack. A bipolar plate assembly may have a pair of separate and distinct bipolar plates that come together to form internal channels for coolant flow and external channels for fuel and oxidant flow in the fuel cell stack. In some cases, the bipolar plates are joined together in order to, among other things, keep the plates together, seal the internal channels from one another, seal the internal channels from the external environment, seal the internal channels from the external channels, seal the internal channels from other parts of the fuel cell stack, or a combination thereof.

### SUMMARY OF SELECT EMBODIMENTS OF THE INVENTION

One embodiment includes a product which may include a bipolar plate assembly. The bipolar plate assembly may be used in a fuel cell stack and may include a first plate and a second plate. The first plate may have a first border and the second plate may have a second border which generally faces and confronts the first border. The bipolar plate assembly may also include an adhesive bond layer. The adhesive bond layer may be located between the first border and the second border, and may be used to join the first plate and the second plate together.

One embodiment includes a method. The method may include providing a first plate and a second plate of a bipolar plate assembly for a fuel cell stack. The first plate may have a first border and the second plate may have a second border. The method may also include locating an adhesive bond material on the first plate adjacent the first border, on the second plate adjacent the second border, or on both the first and second plates adjacent the respective first and second borders. The method may further include bringing the first and second plates together in such a way that the first and second borders confront each other and locate the adhesive bond material therebetween. And the method may include hardening the adhesive bond material to form a dried adhesive bond layer that joins the first plate and the second plate together.

Other embodiments of the invention will become apparent from the detailed description provided hereinafter. It should be understood that the detailed description and specific examples, while disclosing illustrative embodiments of the invention, are intended for purposes of illustration only and are not intended to limit the scope of the invention.

### BRIEF DESCRIPTION OF THE DRAWINGS

Illustrative embodiments of the invention will become more fully understood from the detailed description and the accompanying drawings, wherein:

FIG. 1 is a cross-section schematic of an illustrative fuel cell stack.

FIG. 2 is a cross-section schematic of a border of an illustrative bipolar plate assembly with an illustrative adhesive bond layer.

### DETAILED DESCRIPTION OF ILLUSTRATIVE EMBODIMENTS

The following description of the embodiment(s) is merely illustrative in nature and is in no way intended to limit the invention, its application, or uses.

The figures illustrate an embodiment of a bipolar plate assembly 10 that may include a first or anode plate 12, a second or cathode plate 14, and an adhesive bond layer or bond line 16. The adhesive bond layer 16 may mechanically and structurally join the first plate 12 and the second plate 14 together, and may hold and keep them in contact with each other. The adhesive bond layer 16 may comprise a material that facilitates its application process and that results in a high quality dried bond line that is substantially free of gas bubbles and that ensures intimate contact and bonding between the first and second plates 12 and 14. Though described in the context of anode and cathode plates, in other embodiments substrates of a fuel cell other than anode and cathode plates may be mechanically and structurally joined together by way of the adhesive bond layer 16.

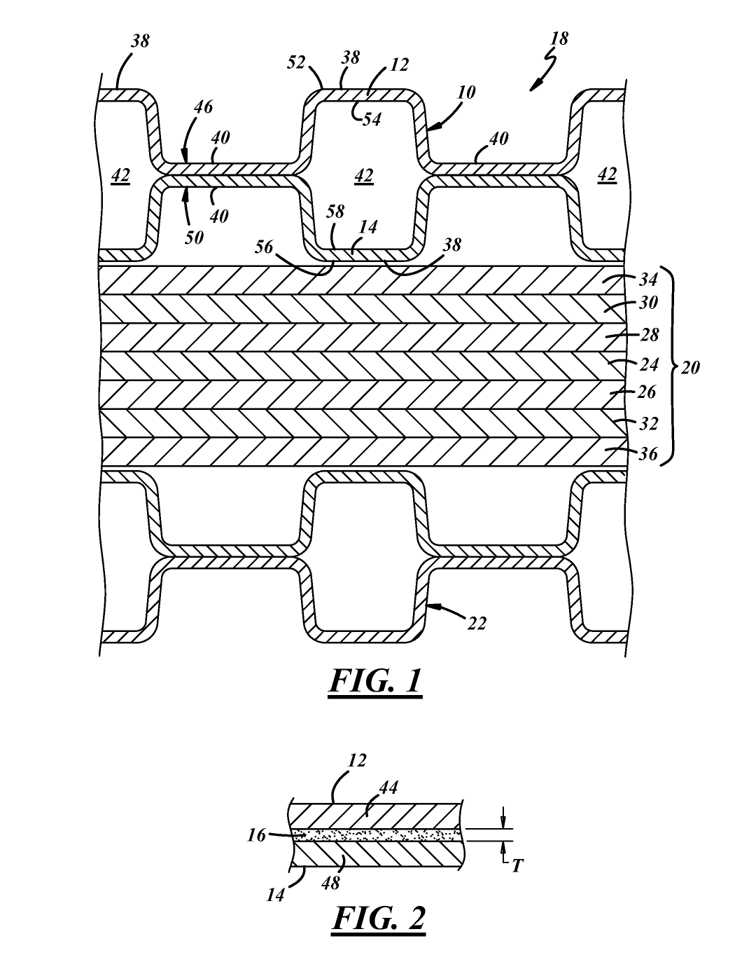

Referring to FIG. 1, the bipolar plate assembly 10 may be but one component of a fuel cell stack 18 which may also include a soft goods portion 20 and a second bipolar plate assembly 22 that is similar to the bipolar plate assembly 10. One illustrative soft goods portion 20 may include a membrane 24, anode and cathode electrodes 26 and 28, microporous layers 30 and 32, and gas diffusion media layers 34 and 36. Each of the bipolar plate assemblies 10 and 22 may include the adhesive bond layer 16 to mechanically and structurally join their respective first and second plates together. In other embodiments, the fuel cell stack 18 may include more, less, or different components than shown and described, or a combination thereof.

The first plate 12 and the second plate 14 may be initially separate and distinct components that are subsequently joined together to form the bipolar plate assembly 10 by way of the adhesive bond layer 16; other ways of joining the plates together, such as riveting, may be used in addition to the adhesive bond layer. The first and second plates 12 and 14 may be composed of various materials having various electrical conductances including, but not limited to, a carbon steel, an aluminum alloy, a titanium, a stainless steel, or other suitable materials. In one embodiment, the first and second plates 12 and 14 may each include a core material sandwiched between a pair of surface materials. And in one embodiment, the first and second plates 12 and 14 may have an exterior plating, such as gold-plating.

Each of the first and second plates 12 and 14 may define external lands 38 and channels 40 that provide reactant gas flow passages. When the first and second plates 12 and 14 are joined, internal coolant flow channels 42 may be defined therebetween. In one general example, the first and second plates 12 and 14 may be formed by cutting metal sheets from a roll stock, treating the surfaces of the metal sheets with one or more coatings that may protect against corrosion, dissolving, and which may enhance electric conductivity, and forming a three-dimensional contour in the metal sheets such as by a drawing, stamping, or other metal forming process. Skilled artisans will appreciate the variations in this forming process, including having more, less, or different steps than described above, or a combination thereof.

Referring to FIGS. 1 and 2, the first plate 12 may have a first border 44 bounding a first central portion 46, and the second plate 14 may have a second border 48 bounding a second central portion 50. The first and second borders 44 and 48 may include a peripheral portion of the respective plate that extends inwardly beyond the mere free edge thereof and toward their respective central portions. The first plate 12 may also have a first outer surface 52 and an oppositely located first inner surface 54, and the second plate 14 may have a second outer surface 56 and an oppositely located second inner surface 58. As shown in FIG. 2, the adhesive bond layer 16 may be located between the first and second plates 12 and 14 adjacent the first and second borders 44 and 48, and may make direct contact with the inner surfaces 54 and 58. If not for the adhesive bond layer 16, in some cases the first and second borders 44 and 48 would come into direct contact with each other. The first and second borders 44 and 48 face and confront each other through the adhesive bond layer 16. The adhesive bond layer 16 may also be located between the first and second plates 12 and 14 adjacent the first and second central portions 46 and 50 where the plates would otherwise directly contact each other such as at the channels 40; here, the adhesive bond layer may seal the internal coolant flow channels 42 from one another.

Wherever located, once dried and hardened the adhesive bond layer 16 may mechanically and structurally join the first plate 12 and the second plate 14 together, and may hold and keep them to each other. In some embodiments, the adhesive bond layer 16 may provide a seal against fluid and gas leakage at the first and second border 44 and 48 or at any location that the adhesive bond layer is located; a sealant may be used in addition to the adhesive bond layer. The adhesive bond layer 16 may provide a sufficient bonding strength that keeps the first and second plates 12 and 14 together in a fuel cell operating environment and throughout the useful life of the fuel cell stack 18. Likewise, the adhesive bond layer 16 may exhibit sufficient chemical resistance, temperature resistance, and corrosion resistance. When measured vertically between the first and second borders 44 and 48, the adhesive bond layer 16 may have a thickness T (FIG. 2) ranging between approximately 10 μm to 60 μm, ranging between approximately 10 μm to 30 μm, and ranging between approximately 10 μm to 20 μm; of course other thicknesses may be suitable.

Before being dried and hardened to form the adhesive bond layer 16, the adhesive bond layer may comprise a material having a viscosity that may facilitate a relatively inexpensive application process such as a screen printing process; of course, application processes need not necessarily be inexpensive in all embodiments. In some embodiments, the adhesive material may have a viscosity ranging between approximately 500 centipoises (cP) to 25,000 cP. Of course other viscosities may be suitable; for example, in other embodiments the viscosity may range more particularly from 500 cP to 5,000 cP, or may range within these limits. Some adhesive bond materials may have a viscosity that may present a challenge in its associated application to the first and second plates 12 and 14; for example, a viscosity that is too high or too low may in some cases be difficult to apply effectively to the plates or may require an application process that is costly.

In one embodiment, and before the adhesive bond layer 16 is dried and hardened, the adhesive bond layer may be comprised of a material that is an emulsion having an epoxy resin. The epoxy resin may be incompatible with water. In select embodiments, the epoxy resin may have a molecular weight ranging from 250 g/mol to 1000 g/mol, or more particularly ranging from 350 g/mol to 400 g/mol. And in one embodiment, the adhesive bond material may comprise an aqueous epoxy emulsion. The aqueous epoxy emulsion may be a two-phase mixture with a water phase and an epoxy phase, where there may be no settling between the water and epoxy and the epoxy globules remain separated from the water. In select embodiments, the water phase may be present in the aqueous epoxy emulsion in 25 to 55 percent volume of the total volume, and the epoxy phase may be present in the aqueous epoxy emulsion in 45 to 75 percent volume of the total volume. Further, in select embodiments, the water phase may be present in the aqueous epoxy emulsion in 35 to 45 percent weight of the total weight, and the epoxy phase may be present in the aqueous epoxy emulsion in 55 to 65 percent weight of the total weight.

One illustrative aqueous epoxy emulsion is called EPI-REZ Resin 3510-W-60 and is available from Hexion Specialty Chemicals, which is headquartered in Columbus, Ohio, U.S.A., (www.hexionchem.com). In general, aqueous epoxy emulsions, such as EPI-REZ Resin 3510-W-60, may be suitable materials for use as the adhesive bond layer 16 because they may have a viscosity that facilitates a relatively inexpensive application process such as a screen printing process, they may have a relatively efficient and quick drying and hardening process that produces a substantially gas-bubble-free bond line with a substantially homogeneous thickness and coverage area, and they may be environmentally safer as compared to other adhesives. Other materials may be used for the adhesive bond layer 16 that may not necessarily exhibit all or any of these characteristics. In some embodiments, the aqueous epoxy emulsion may comprise surfactants including ionic surfactants such as carboxylates, sulfates or sulfonates, or alkylamines; non-ionic surfactants such as esters of fatty acids or alkyphenols; polymeric surfactants, amphiphilic surfactants such as sodium alkylsulfates, amphoteric surfactants, among other examples. Specific surfactant examples include TERGITOL L-101 Surfactant, TERGITOL XD Surfactant, and TRITON CA Surfactant, all available from The Dow Chemical Company, which is headquartered in Midland, Mich., U.S.A., (www.dow.com). And in some embodiments, the adhesive bond layer 16 may comprise a material with an epoxy resin and without water.

The adhesive bond material may be located and applied between the first and second plates 12 and 14 by a number of application processes. In one embodiment, the adhesive bond material may be applied directly to the first inner surface 54 at the first border 44, may be applied directly to the second inner surface 58 at the second border 48, or may be applied to both.

One illustrative application process is a screen printing process. A typical screen printing process may be relatively inexpensive and may be suitable for use with an aqueous epoxy emulsion or another material of similar viscosity. Of course, other application processes may be suitable with an aqueous epoxy emulsion, and other adhesive bond materials may be used that are not necessarily suitable with a screen printing process. Indeed, the exact application process used may be influenced by, among other factors, characteristics of the adhesive bond material such as its composition and viscosity. In one illustrative screen printing process, the thickness and uniformity of the applied material can be sufficiently controlled, and the covered area and volume of the applied material can be sufficiently controlled. In a typical screen printing process, a screen with areas blocked and unblocked may be placed over a substrate such as the first and second plates 12 and 14. A material, such as an aqueous epoxy emulsion, may then be put over and forced through the screen and may be applied to the underlying substrate only at the unblocked areas. In one example with the first and second plates 12 and 14, the unblocked areas may be located over the first and second borders 44 and 48.

The first and second plates 12 and 14 may be brought together so that the first and second borders 44 and 48 confront and meet each other, and sandwich the adhesive bond material therebetween. The adhesive bond material may then be interposed the first and second borders 44 and 48.

The adhesive bond material may then be dried and hardened in order to form the adhesive bond layer 16 that may structurally and mechanically join the first plate 12 and the second plate 14 together. The exact hardening process performed may be influenced by, among other factors, the exact adhesive bond material used. For example, the hardening process may include a drying process, a heating process, a curing process, or a combination thereof. The hardening process may involve exposure to elevated or room temperatures, forced air movement, ultraviolet radiation, curing agents, chemical additives, and the like. Skilled artisans will appreciate the variations in the hardening processes, including having more, less, or different processes and steps than mentioned above, or a combination thereof. In an example with an aqueous epoxy emulsion, during one illustrative hardening process the water may be completely evaporated which may result in a substantially gas-bubble-free bond line. And in an example with an aqueous epoxy emulsion, the emulsion may be dried and cured in that order.

The above description of embodiments of the invention is merely illustrative in nature and, thus, variations thereof are not to be regarded as a departure from the spirit and scope of the invention.

What is claimed is:

1. A product comprising:
a bipolar plate assembly for a fuel cell stack, the bipolar plate assembly including a first plate having a first border and including a second plate having a second border that generally faces and confronts the first border, the bipolar plate assembly including an adhesive bond layer located between the first border and the second border to join the first plate and the second plate together.

2. A product as set forth in claim 1 wherein, before the adhesive bond layer is in a hardened state, the adhesive bond layer is a material comprising an emulsion with an epoxy resin.

3. A product as set forth in claim 1 wherein, before the adhesive bond layer is in a hardened state, the adhesive bond layer is a material comprising an aqueous epoxy emulsion.

4. A product as set forth in claim 3 wherein the first and second plates comprise an exterior gold-plating.

5. A product as set forth in claim 3 wherein, before the adhesive bond layer is in a hardened state, the adhesive bond layer is a material that is applied to the first border, to the second border, or to both the first and second borders via a screen printing process.

6. A product as set forth in claim 1 wherein the adhesive bond layer has a thickness measured between the first and second borders ranging between about 10 μm to 60 μm.

7. A product as set forth in claim 1 wherein the adhesive bond layer has a thickness measured vertically between the first and second borders ranging between about 10 μm to 30 μm.

8. A product as set forth in claim 1 wherein the adhesive bond layer has a thickness measured vertically between the first and second borders ranging between about 10 μm to 20 μm.

9. A product as set forth in claim 1 wherein, before the adhesive bond layer is in a hardened state, the adhesive bond layer is a material having a viscosity ranging between about 500 cP to 25,000 cP.

10. A product as set forth in claim 2 wherein the adhesive bond layer is substantially free of gas bubbles.

11. A method comprising:
providing a first plate and a second plate of a bipolar plate assembly for a fuel cell stack, the first plate having a first border and the second plate having a second border that generally faces and confronts the first border;
locating an adhesive bond material on the first plate adjacent the first border, on the second plate adjacent the second border, or on both the first and second plates adjacent the respective first and second borders;
bringing the first plate and the second plate together so that the first and second borders confront each other and locate the adhesive bond material between the first and second borders; and
hardening the adhesive bond material to form a dried adhesive bond layer that joins the first plate and the second plate together.

12. A method as set forth in claim 11 wherein the adhesive bond material comprises an aqueous epoxy emulsion.

13. A method as set forth in claim 12 wherein the first and second plates comprise an exterior gold-plating.

14. A method as set forth in claim 12 wherein locating the adhesive bond material is performed via a screen printing process.

15. A method as set forth in claim 11 wherein the adhesive bond material comprises an emulsion with an epoxy resin.

16. A method as set forth in claim 11 wherein the adhesive bond material has a viscosity ranging between about 500 cP to 25,000 cP.

17. A method as set forth in claim 11 wherein the adhesive bond layer has a thickness measured vertically between the first and second borders ranging between about 10 μm to 60 μm.

18. A method as set forth in claim 11 wherein the adhesive bond layer has a thickness measured vertically between the first and second borders ranging between about 10 μm to 30 μm.

19. A method as set forth in claim 11 wherein the adhesive bond layer has a thickness measured vertically between the first and second borders ranging between about 10 μm to 20 μm.

20. A method as set forth in claim 11 wherein hardening the adhesive bond material is performed via a heating process.

21. A method as set forth in claim 11 wherein hardening the adhesive bond material is performed via a drying process.

22. A method as set forth in claim 11 wherein the adhesive bond layer is substantially free of gas bubbles.
